(19) United States
(12) Patent Application Publication
(10) Pub. No.: US 2021/0115162 A1
(43) Pub. Date: Apr. 22, 2021

(54) Pregelatinized Starches Having High Process Tolerance and Methods for Making and Using Them

(71) Applicant: Tate & Lyle Ingredients Americas LLC, Hoffman Estates, IL (US)

(72) Inventors: James Thomas Smoot, Hoffman Estates, IL (US); Mark Beltz, Hoffman Estates, IL (US); Yuqing Zhou, Hoffman Estates, IL (US); Jarred Lawson, Hoffman Estates, IL (US); Jennifer Quigley, Hoffman Estates, IL (US)

(21) Appl. No.: 16/604,562

(22) PCT Filed: Apr. 11, 2018
(86) PCT No.: PCT/US2018/027136

§ 371 Date: Oct. 10, 2019

Related U.S. Application Data
(60) Provisional application No. 62/484,790, filed on Apr. 12, 2017.
(60) Provisional application No. 62/547,695, filed on Aug. 18, 2017.

(51) Int. Cl. C08B 30/14; C08B 31/00; A23L 29/212; A23L 27/60

(52) U.S. Cl. CPC C08B 30/14; C08B 31/006; A23V 2002/00; A23L 27/60; A23L 29/212

(57) ABSTRACT

The present disclosure relates to pregelatinized starches having a high degree of process tolerance, and methods for making and using them. In one aspect, the disclosure provides a pregelatinized starch having no more than 15 wt % solubles and a sedimentation volume in the range of 15 mL/g to 45 mL/g, the pregelatinized starch comprising starch granules, wherein at least 50% of the starch granules swell but do not substantially fragment when processed in 95° C. water, the pregelatinized starch being in a substantially planar form. In another aspect, the disclosure provides a pregelatinized, drum-dried starch having no more than 15 wt % solubles and a sedimentation volume in the range of 15 mL/g to 45 mL/g, the pregelatinized starch comprising starch granules, wherein at least 50% of the starch granules swell but do not substantially fragment when processed in 95° C. water.

### CROSS-REFERENCE TO RELATED APPLICATIONS

This application claims the benefit of priority of U.S. Provisional Patent Application No. 62/484,790, filed Apr. 12, 2017, and U.S. Provisional Patent Application No. 62/547,695, filed Aug. 18, 2017, each of which is hereby incorporated herein by reference in its entirety.

### BACKGROUND OF THE DISCLOSURE

### Field of the Disclosure

This disclosure relates generally to starches. More particularly, the present disclosure relates to pregelatinized starches having a high degree of process tolerance, and methods for making and using them.

### Technical Background

Food-grade starches are commonly used to provide desirable qualities to various foodstuffs. For example, cross-linked and stabilized modified food starches are used widely for texturizing of foods. The stabilization imparts freeze-thaw stability to a starch, while cross-linking imparts process tolerance. Stabilization can be provided via substitution of the starch hydroxyl groups by groups such as hydroxypropyl ethers or acetyl esters. Process tolerance can be obtained by cross-linking with groups such as phosphate (e.g., via treatment of the starch with phosphorous oxychloride) or adipate (e.g., via treatment with acetic-adipic mixed anhydride). As used herein, the term “process tolerant” or “process tolerance” with respect to a starch means that the individual granules of the starch may swell in water when cooked, yet retain a significant portion of their granular nature throughout the process. Thus, process-tolerant starches can resist breaking down into fragments and can resist dissolution when processed. Such behavior can allow the starch to thicken a food without causing undesired gelation, cohesiveness or stringiness. Accordingly, process-tolerant starches are highly desirable for use in foods such as gravies, sauces and dressings, as well as certain fruit fillings and dairy products.

In many applications, a starch needs to be cooked, often at relatively high temperatures approaching 100° C., in order to provide a desired textural behavior in a given food product. However, there are various techniques known to pre-cook, or “pregelatinize,” a starch; such pregelatinized starches can be used to provide a desired viscosity in a food product without requiring the food product to be heated at such high temperatures. Some such pregelatinization methods include spray cooking, drum drying, and pre-swelling in aqueous alcohol. Drum drying involves the passing of a moistened starch material over a hot rotating drum and squeezing it through a narrow opening made between the drum and another surface (e.g., another rotating drum). The process is performed at temperatures sufficient to not only pregelatinize the starch but also to dry much of the water out of it, providing the starch in the form of a dried sheet or flakes, which can be processed to a desired flake or particle size. While drum drying is the least expensive of these technologies, as the inventors have determined (and as described in more detail below), drum drying has a negative impact on the integrity of the starch granules, and can provide starch materials that provide undesirable textures to foods, such as cohesiveness and stringiness. Drum-dried starches typically provide dispersions having lower viscosity than do spray-cooked and alcohol-processed starches when produced at equivalent process tolerance. And they can have a high degree of solubles, which can result in cohesiveness, which is undesirable, Drum drying can also result in significantly reduced process tolerance.

### SUMMARY OF THE DISCLOSURE

In one aspect, the disclosure provides a pregelatinized, drum-dried starch having no more than 15 wt % solubles and a sedimentation volume in the range of 15 mL/g to 45 mL/g, the pregelatinized starch comprising starch granules, wherein at least 50% of the starch granules swell but do not substantially fragment when processed in 95° C. water.

In another aspect, the disclosure provides a pregelatinized starch having no more than 15 wt % solubles and a sedimentation volume in the range of 15 mL/g to 45 mL/g, the pregelatinized starch comprising starch granules, wherein at least 50% of the starch granules swell but do not substantially fragment when processed in 95° C. water, the pregelatinized starch being in a substantially planar form.

In another aspect, the disclosure provides a method for making a pregelatinized starch as described herein, the method including providing an ungelatinized starch moistened with an aqueous medium; and drum-drying the moistened ungelatinized starch under conditions sufficient to pregelatinize the starch.

In another aspect, the disclosure provides a method for preparing a food product, comprising dispersing a pregelatinized starch as described herein in a food product.

Another aspect of the disclosure is a food product comprising a starch as described herein.

### BRIEF DESCRIPTION OF THE DRAWINGS

FIG. 1 is a micrograph of a conventional non-pregelatinized hydroxypropylated modified starch,

FIG. 2 is a micrograph of the starch of FIG. 1 after being subjected to RVA conditions.

FIG. 3 is a micrograph of a conventional pregelatinized hydroxypropylated modified starch.

FIG. 4 is a micrograph of an example of a drum-dried starch.

FIG. 5 is a set of photographs of standards for stringiness.

FIG. 6 is a set of photographs of standards for settling speed.

FIG. 7 is a set of photographs of standards for undissolved particles.

FIG. 8 is a micrograph of a pregelatinized starch of the disclosure after being subjected to RVA conditions.

FIGS. 9 and 10 are micrographs of starch granules of the disclosure after dispersion and after shear processing, respectively.

FIGS. 11 and 12 are graphs comparing the properties of a starch of the disclosure with a conventional agglomerated starch.

FIGS. 13 and 14 are viscosity measurements of pre-emulsions used in the preparation salad dressing according to one example.

FIGS. 15 and 16 are micrographs of a pre-emulsion and of an emulsified dressing according to one example.

### DETAILED DESCRIPTION

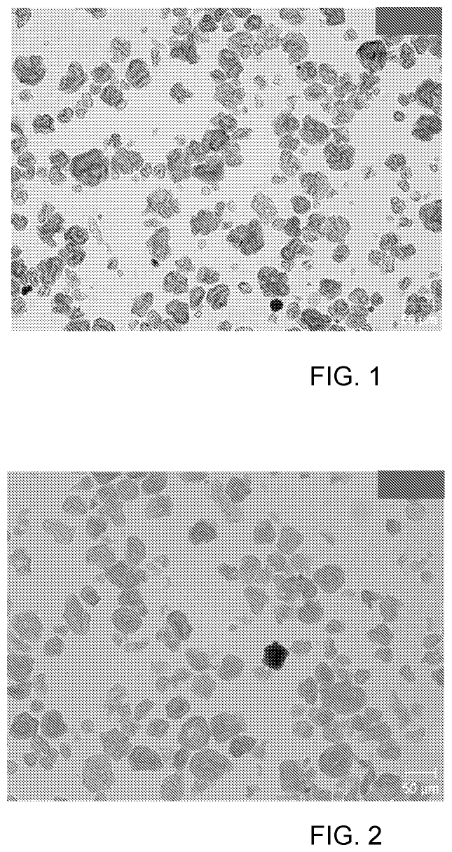

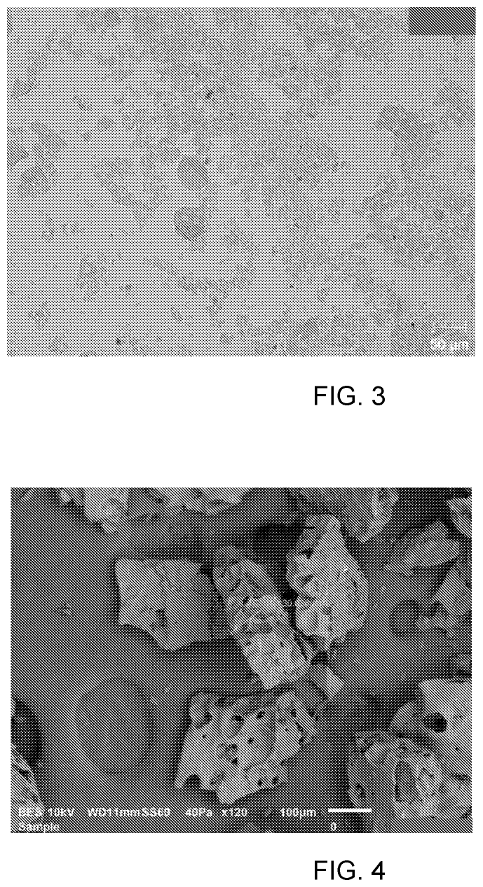

While drum drying is a cost-effective method for pregelatinization, as noted above, it can have an undesirable impact on starch performance. For example, FIG. 1 is a micrograph of a conventional non-pregelatinized hydroxypropylated modified starch, dispersed in water under the RVA conditions described below. As is evident, the individual granules of the starch remain substantially intact. When this starch is pregelatinized by spray-cooking then dispersed in water under the RVA conditions described below, it results in granules that swell but do not substantially fragment or disintegrate, as shown in FIG. 2. In contrast, when the starch of FIG. 1 is pregelatinized by drum drying, the resulting planar sheet- or flake-like particles break apart when reintroduced to water yielding mostly particles which are visibly evident to be fragments of starch granules as shown in FIG. 3. These granule fragments are visually distinct from the intact unfragmented granules of FIGS. 1 and 2. Such fragmentation of the starch granules can lead to a loss in process tolerance, as well as an increased amount of soluble starch, which can provide undesirable textural qualities to the starch.

Surprisingly, the present inventors have been able to use drum drying to provide pregelatinized starch materials that can provide both process tolerance and highly desirable texturizing properties. Thus, one aspect of the disclosure is a pregelatinized starch having less than 15 wt % solubles and a sedimentation volume in the range of 15 mL/g to 45 mL/g. The pregelatinized starch comprises starch granules; at least 50% (e.g., at least 80%) of the starch granules swell but do not substantially fragment when processed in water. The pregelatinized starch of this aspect of the disclosure is a drum-dried starch.

Moreover, the pregelatinized starches of the disclosure can be provided in substantially planar form. Accordingly, another aspect of the disclosure is a pregelatinized starch having less than 15 wt % solubles and a sedimentation volume in the range of 15 mL/g to 45 mL/g. The pregelatinized starch comprises starch granules; at least 50% (e.g., at least 80%) of the starch granules swell but do not substantially fragment when processed in 95° C. water. The pregelatinized starch is in a substantially planar form. As used herein, a “substantially planar” form means that at least 50%, at least 75%, or even at least 90% of the material by weight is in the form of individual sheet- or flake-like particles of material each having a thickness that is no more than % (e.g., in certain embodiments as otherwise described herein, no more than ⅓ or no more than ¼) of each of the length and the width of the particle. Thickness is measured as the average thickness along the shortest dimension, while length is measured as the longest dimension perpendicular to the thickness, and width is measured as the longest dimension perpendicular to both the thickness and the length. In certain embodiments as otherwise described herein, a pregelatinized starch of this aspect of the disclosure is a drum-dried starch.

Sedimentation volume can be used as a measure of process tolerance, as the person of ordinary skill in the art will appreciate. As used herein, sedimentation volume is the volume occupied by one gram of cooked starch (dry basis) in 100 grams (i.e. total, including the starch) of salted buffer solution. This value is also known in the art as “swelling volume.” As used herein, the “salted buffer solution” refers to a solution prepared according to the following steps:
a) Using a top loader balance, weigh out 20 grams of sodium chloride into a 2 liter volumetric flask containing a stir bar;
b) To this add RVA pH 6.5 buffer (purchased from Ricca Chemical Company) so that the flask is at least half full;
c) Stir to mix until sodium chloride is dissolved;
d) Add additional RVA pH 6.5 buffer to a final volume of 2 liters;
   Sedimentation volumes as described herein are determined by first cooking the starch at 5% solids in the salted buffer solution by suspending a container containing the slurry in a 95° C. water bath and stirring with a glass rod or metal spatula for 6 minutes, then covering the container and allowing the paste to remain at 95° C. for an additional 20 minutes. The container is removed from the bath and allowed to cool on the bench. The resulting paste is brought back to the initial weight by addition of water (i.e. to replace any evaporated water) and mixed well. 20.0 g of the paste (which contains 1.0 g starch) is weighted into a 100 mL graduated cylinder containing salted buffer solution, and the total weight of the mixture in the cylinder is brought to 100 g using the buffer. The cylinder is allowed to sit undisturbed at room temperature (about 23° C.) for 24 hours. The volume occupied by the starch sediment (i.e., as read in the cylinder) is the sedimentation volume for 1 g of starch, i.e., in units of mL/g.

Starches with relatively low sedimentation volumes (e.g., in the range of 15 mL/g to 45 mL/g) have good process tolerance. In certain embodiments as otherwise described herein, the pregelatinized starch has a sedimentation volume in the range of 15 mL/g to 40 mL/g, or 15 mL/g to 35 mL/g, or 15 mL/g to 30 mL/g, or 15 mL/g to 25 mL/g, or 15 mL/g to 20 mL/g, or 20 mL/g to 45 mL/g, or 20 mL/g to 35 mL/g, or 20 mL/g to 30 mL/g, or 20 mL/g to 25 mL/g, or 25 mL/g to 45 mL/g, or 25 mL/g to 40 mL/g, or 25 mL/g to 35 mL/g, or 30 mL/g to 45 mL/g, or 30 mL/g to 40 mL/g, or 35 mL/g to 45 mL/g. In certain particular embodiments as otherwise described herein, the pregelatinized starch has a sedimentation volume in the range of 20 mL/g to 25 mL/g.

In the sedimentation volume test described above, the supernatant above the granular sediment contains soluble starch, i.e., the portion of the starch that is not retained by the inhibited granules of the sediment. The amount of soluble starch is quantified by withdrawing a portion of the supernatant, and quantitatively hydrolyzing the starch to dextrose using acid or enzyme, then measuring the concentration of dextrose, e.g., using an instrumental analyzer such as a glucose analyzer available from YSI Incorporated. The concentration of dextrose in the supernatant can be converted algebraically to the percent solubles (i.e., by weight) value of the starch.

If a starch releases a high degree of material from its granules when processed in a food, it can provide a degree of cohesiveness or stringiness to the food. While this is desirable in some foods, it is very undesirable in other foods. Accordingly, for certain uses, e.g., dressings, sauces and gravies, and certain fruit fillings and dairy products, a pregelatinized starch with a low amount of solubles is desired. Conventional drum-dried starches tend to have a high degree of solubles. In contrast, the pregelatinized starches of the disclosure have no more than 15% solubles. Accordingly, the pregelatinized starches of the disclosure can provide desired texturizing properties without an undesirable amount of cohesiveness or stringiness. In certain embodiments as otherwise described herein, a pregelatinized starch has no more than 10% solubles. In certain particular embodiments as otherwise described herein, a pregelatinized starch has no more than 5% solubles, e.g., no more than 4% solubles, or no more than 2% solubles.

As the person of ordinary skill in the art will appreciate, the pregelatinized starches of the disclosure include starch granules, i.e., the individual packets in which the amylose and amylopectin of the starch is substantially contained. An individual physical particle of dried starch will contain a great many such granules, as would be apparent to the person of ordinary skill in the art. The granule size will depend on the plant source of the starch; rice starch granules are relatively small (1-5 microns in size), while potato starch granules are relatively large (several tens of microns in size).

Notably, in the pregelatinized starches of the disclosure, the starch granules swell but do not substantially fragment when processed in 95° C. water. As used herein, “processed in 95° C. water” means the conditions of a Rapid Visco Analyzer (RVA) experiment: Viscosity is measured by RVA at 5% solids in a pH 6.5 phosphate buffer at 1% NaCl. The pregelatinized starch is added to water at 35° C., and stirred at 35° C. at 700 rpm for one minute and at 160 rpm for 14 minutes; stirring at 160 rpm continues throughout the measurement. The temperature is linearly ramped to 95° C. over 7 minutes, then held at 95° C. for 10 minutes, then linearly ramped down to 35° C. over 6 minutes, then finally held at 35° C. for 10 minutes. Viscosity can be measured at this point, and the resulting starch dispersion can be stained with iodine and observed with a microscope to determine the degree of fragmentation. The degree of fragmentation can be determined by comparing the area in the field of view of the microscope taken by unfragmented granules as a fraction of the total area in the field of view taken by unfragmented granules and granule fragments. For example, in certain embodiments, a pregelatinized starch as otherwise described herein has a degree of fragmentation of no more than 50%, i.e., the area of unfragmented granules divided by the sum of the areas of unfragmented granules and granule fragments is no more than 50%, In other embodiments, a pregelatinized starch as otherwise described herein has a degree of fragmentation of no more than 30%, or even no more than 10%.

In certain embodiments of the pregelatinized starches as otherwise described herein, at least 75% of the starch granules swell but do not substantially fragment when processed in 95° C. water. In certain particular embodiments of the pregelatinized starches as otherwise described herein, at least 90% of the starch granules swell but do not substantially fragment when processed in 95° C. water.

As noted above, the starches of the disclosure are pregelatinized. As the person of ordinary skill in the art will appreciate, the pregelatinization process disorganizes the semicrystalline structure of the native starch granule, such that if does not later need to be processed at high temperatures to provide viscosity to a food. As used herein, a “pregelatinized” starch has no more than 25% of its granules exhibiting birefringence, i.e., a high-extinction, so-called “Maltese” cross through the granule when viewed by polarization microscopy. For example, in certain embodiments, no more than 10%, no more than 5%, or even no more than 2% of the granules of the pregelatinized starch exhibit birefringence.

Notably, in certain aspects of the disclosure, the pregelatinized starch as otherwise described herein is a drum-dried starch. While drum drying is an economically attractive pregelatinization method, it can cause undesirable damage to a starch material. For example, conventional drum-dried starches can suffer from undesirable properties such as a high degree of cohesiveness and stringiness, resulting from disintegration of starch granules causing a high amount of soluble material. The pregelatinized starches of this aspect of the present disclosure, in contrast, have low amounts of solubles and good processability despite being drum dried. Conventional drum drying equipment and processes can be used to provide the drum-dried starches of the disclosure. As the person of ordinary skill in the art will appreciate, a typical drum dryer includes one or two horizontally-mounted hollow cylinder(s), with a feeding system configured to apply a thin layer of liquid, slurry or puree to the face of one or both cylinders. In a drying operation, the drums are heated to dry and, depending on the temperature, cook the material of the liquid, slurry or puree to form a thin solid layer of material, which can be removed from the drum by a scraper and ground or milled to a desired size. Drum dryers are described in more detail in J. Tang et al., Drum Drying, pages 211-14 in Encyclopedia of Agricultural, Food, and Biological Engineering, Marcel Dekker, 2003, which is hereby incorporated herein by reference in its entirety. Particular drum drying apparatuses and processes are described below; the person of ordinary skill in the art will appreciate that a variety of drum- and roll-drying apparati and conditions can be used to provide the “drum-dried” materials described herein. The person of ordinary skill in the art will appreciate that drum-dried starch materials have a different dry appearance than do spray-cooked or alcohol-processed starches. A micrograph of an example of a drum-dried starch is provided in FIG. 4. For example, drum drying can provide dry starch materials having a sheet-like or flake-like particle appearance, and/or a cratered appearance as described in more detail below, and as shown in FIG. 4.

In certain embodiments as otherwise described herein, the particles of the pregelatinized starch (e.g., at least 50%, at least 75%, or at least 90% by weight thereof) have a substantially non-rounded shape (e.g., a jagged shape). Such particles can be made, for example, by drum drying as described above; individual particles can be formed by breaking or grinding of a dried sheet of material. The substantially non-rounded shape of such material is in contrast to the rounded particles made by spray cooking or alcohol processing.

In certain embodiments as otherwise described herein, the particles of the pregelatinized starch (e.g., at least 50%, at least 75%, or at least 90% by weight thereof) have a cratered surface. An example of such a surface is shown in FIG. 4. Such particles can be made, for example, by drum drying as described above; especially at the higher drying temperatures desirable to give substantial pregelatinization, drum-drying can provide starch particles having a cratered surface, resulting from water escaping from the drying material in the form of steam.

In certain embodiments as otherwise described herein, at least 75% by weight of the pregelatinized starch (e.g., 90% by weight thereof) is in the form of individual sheet- or flake-like particles of material each having a thickness that is no more than ½ of each of the length and the width of the particle. Such particles can be made, for example, by drum drying as described above, with an optional milling or grinding step to provide the particle size.

In certain embodiments as otherwise described herein, at least 50% by weight of the pregelatinized starch (e.g., at least 75% or at least 90% by weight thereof) is in the form of individual sheet- or flake-like particles of material each having a thickness that is no more than ⅓ of each of the length and the width of the particle. In certain particular embodiments as otherwise described herein, at least 50% by weight of the pregelatinized starch (e.g., at least 75% or at least 90% by weight thereof) is in the form of individual sheet- or flake-like particles of material each having a thickness that is no more than ¼ of each of the length and the width of the particle. Such particles can be made, for example, by drum drying as described above, with an optional milling or grinding step to provide the desired particle size. Advantageously, in drum-drying processes the particle size can be manipulated over a wider range than is typical for spray-cooked and/or agglomerated particles. As the dried starch is produced in the first instance as relatively large sheets, the particle size can vary from large flakes to any finer grind desired. For example, drum-dried sheets can be ground to particles hundreds of microns (e.g., 750 microns) in major dimension to provide a starch providing a pulpy texture to a food, down to on the order of 5-10 microns for a starch providing a smooth texture to a food.

As the person of ordinary skill in the art will appreciate, the pregelatinized starches described herein can be provided in a variety of particle sizes (i.e., in substantially dry form). For example, in certain embodiments as otherwise described herein, at least 50% by weight of the pregelatinized starch (e.g., at least 75% or at least 90% by weight thereof) is in the form of individual sheet- or flake-like particles of material each having a thickness in the range of 20 microns to 250 microns. For example, in various embodiments as otherwise described herein, at least 50% by weight of the pregelatinized starch (e.g., at least 75% or at least 90% by weight thereof) is in the form of individual sheet- or flake-like particles of material each having a thickness in the range of 20 microns to 200 microns, or 20 microns to 150 microns, or 20 microns to 125 microns, or 20 microns to 100 microns, or 20 microns to 75 microns, or 30 microns to 250 microns, or 30 microns to 200 microns, or 30 microns to 150 microns, or 30 microns to 125 microns, or 30 microns to 100 microns, or 50 microns to 250 microns, or 50 microns to 200 microns, or 50 microns to 150 microns, or 50 microns to 125 microns, or 75 microns to 250 microns, or 75 microns to 200 microns, or 75 microns to 150 microns, or 75 microns to 125 microns, or 100 microns to 250 microns, or 100 microns to 200 microns. In certain embodiments as otherwise described herein, at least 50% by weight of the pregelatinized starch (e.g., at least 75% or at least 90% by weight thereof), i.e., particles having the thicknesses described above, is in the form of individual sheet- or flake-like particles of material each having a length of at least 50 microns, or at least 100 microns, or at least 200 microns, for example, at least 300 microns or at least 400 microns, or in the range of 50 microns to 1000 microns, or 50 microns to 800 microns, or 50 microns to 500 microns, or 50 microns to 250 microns, or 100 microns to 1000 microns, or 100 microns to 800 microns, or 100 microns to 500 microns, or 100 microns to 250 microns, 200 microns to 1000 microns, or 200 microns to 800 microns, or 200 microns to 500 microns, or 300 microns to 1000 microns, or 300 microns to 800 microns, or 300 microns to 500 microns, or 400 microns to 1000 microns, or 400 microns to 800 microns. Similarly, in certain embodiments as otherwise described herein, at least 50% by weight of the pregelatinized starch (e.g., at least 75% or at least 90% by weight thereof), i.e., particles having the thicknesses and lengths described above, is in the form of individual sheet- or flake-like particles of material each having a width of at least the range of at least 50 microns, or at least 100 microns, or at least 200 microns, for example, at least 300 microns or at least 400 microns, or in the range of 50 microns to 1000 microns, or 50 microns to 800 microns, or 50 microns to 500 microns, or 50 microns to 250 microns, or 100 microns to 1000 microns, or 100 microns to 800 microns, or 100 microns to 500 microns, or 100 microns to 250 microns, 200 microns to 1000 microns, or 200 microns to 800 microns, or 200 microns to 500 microns, or 300 microns to 1000 microns, or 300 microns to 800 microns, or 300 microns to 500 microns, or 400 microns to 1000 microns, or 400 microns to 800 microns. The planar particles described above can be ground even smaller, e.g., to provide a particle size down to the range of 1-20 microns (e.g., 5-10 microns).

For example, in certain embodiments as otherwise described herein, at least 50% by weight of the pregelatinized starch (e.g., at least 75% or at least 90% by weight thereof) is in the form of individual sheet- or flake-like particles of material each having a thickness in the range of 20 microns to 250 microns; a length of at least 50 microns; and a width of at least 50 microns. In other embodiments as otherwise described herein, at least 50% by weight of the pregelatinized starch (e.g., at least 75% or at least 90% by weight thereof) is in the form of individual sheet- or flake-like particles of material each having a thickness in the range of 20 microns to 250 microns; a length of at least 100 microns; and a width of at least 100 microns. In other embodiments as otherwise described herein, at least 50% by weight of the pregelatinized starch (e.g., at least 75% or at least 90% by weight thereof) is in the form of individual sheet- or flake-like particles of material each having a thickness in the range of 20 microns to 250 microns; a length in the range of 200 microns to 1000 microns; and a width in the range of 200 microns to 1000 microns. In other embodiments as otherwise described herein, at least 50% by weight of the pregelatinized starch (e.g., at least 75% or at least 90% by weight thereof) is in the form of individual sheet- or flake-like particles of material each having a thickness in the range of 50 microns to 250 microns; a length in the range of 100 microns to 1000 microns; and a width in the range of 100 microns to 1000 microns. The person of ordinary skill in the art will appreciate that in various other embodiments, at least 50% by weight of the pregelatinized starch (e.g., at least 75% or at least 90% by weight thereof) is in the form of individual sheet- or flake-like particles of material each having any combination of the thicknesses, lengths and widths as described above (e.g., such that a sheet-like or flake-like particle is formed).

In certain embodiments as otherwise described herein, the pregelatinized starch is stabilized. Stabilization can be used, for example, to improve the stability of the starch in a food product, e.g., by improving the freeze-thaw performance of the starch. The person of ordinary skill in the art will appreciate that such stabilization can be provided in a variety of ways.

For example, in certain embodiments as otherwise described herein, the pregelatinized starch is stabilized by acylation, e.g., acetylation. Such a pregelatinized starch can, for example, have an acetylation level in the range of 1% to 4% by weight, e.g., 1% to 3.5%, or 1% to 3%, or 1% to 2.5%, or 1.4% to 4%, or 1.4% to 3.5%, or 1.4% to 3%, or 1.4% to 2.5%, 011.8 to 4%, or 1.8% to 3.5%, or 1.8% to 3%, all on a dry solids basis. In certain embodiments as otherwise described herein, the pregelatinized starch has an acetylation level of 1.8% to 2.5% by weight. Weight percent acetylations are determined as % CH₃CO—.

For example, in certain embodiments as otherwise described herein, the pregelatinized starch is stabilized by etherification, e.g., hydroxypropylation. Such a pregelatinized starch can, for example, have a hydroxypropylation level in the range of 0.5% to 10% by weight, e.g., 0.5% to 8%, or 0.5% to 7%, or 0.5% to 6%, or 1% to 10%, or 1% to 8%, or 1% to 7%, or 1% to 6%, or 2% to 10%, or 2% to 8%, or 2% to 7%, or 2% to 6%, or 4% to 10%, or 4% to 8%, or 4% to 7%, or 4% to 6%, all on a dry solids basis. In certain embodiments as otherwise described herein, the pregelatinized starch has a hydroxypropylation level in the range of 2% to 7% by weight. Weight percent hydroxypropylation is determined as % HO—CH(CH₃)—CH₂—O—.

Of course, in other embodiments, the stabilization can be provided by different chemistries, e.g., a different ester or a different ether. Combinations of stabilization chemistries can also be used.

In certain embodiments as otherwise described herein, the pregelatinized starch is cross-linked. As the person of ordinary skill in the art will appreciate, crosslinking can be used to improve the process tolerance of the starch, e.g., by providing a desired sedimentation volume as otherwise described herein. In certain embodiments as otherwise described herein, the pregelatinized starch is cross-linked with phosphate (e.g., by treatment with phosphorus oxychloride or metaphosphate). In other embodiments as otherwise described herein, the pregelatinized starch is cross-linked with adipate (e.g., by treatment with an adipic acid derivative such as acetic/adipic mixed anhydride). The person of ordinary skill in the art will, based on the present disclosure, select a degree of cross-linking that provides the desired sedimentation volume, solubility characteristics, and other characteristics to the pregelatinized starch.

The pregelatinized starch can be treated in a number of other manners, as would be apparent to the person of ordinary skill in the art. For example, physical treatments known in the art (e.g., heat-and-moisture-treatment, dry heat treatment, heat treatment in alcohol, or coating with other hydrocolloids) coating with can be used in conjunction with or instead of cross-linking to provide the desired sedimentation volume, solubility characteristics, and other characteristics to the starch.

A variety of different starch sources can be used to provide the starches of the disclosure. The person of ordinary skill in the art will be able to used conventional microscopy methods and analytical techniques to distinguish between types of starches. For example, in certain embodiments as otherwise described herein, the pregelatinized starch is a corn starch. In other embodiments as otherwise described herein, the pregelatinized starch is a tapioca or cassava starch. In other embodiments as otherwise described herein, the pregelatinized starch is a potato starch. In other embodiments as otherwise described herein, the pregelatinized starch is a rice starch or a wheat starch. In still other embodiments as otherwise described herein, the pregelatinized starch is derived from acorns, arrowroot, arracacha, bananas, barley, breadfruit, buckwheat, canna, colacasia, katakuri, kudzu, rnalanga, millet, oats, oca, polynesian arrowroot, sago, sorghum, sweet potatoes, rye, taro, chestnuts, water chestnuts, yams, or beans such as, for example, favas, lentils, mung beans, peas, or chickpeas. The starches can be waxy or non-waxy. Moreover, as the person of ordinary skill in the art will appreciate, the starch feedstock may be purified, e.g., by conventional methods, to reduce undesirable flavors, odors, or colors, e.g., that are native to the starch or are otherwise present. For example, methods such as washing (e.g., alkali washing), steam stripping, ion exchange processes, dialysis, filtration, bleaching such as by chlorites, enzyme modification (e.g., to remove proteins), and/or centrifugation can be used to reduce impurities. The person of ordinary skill in the art will appreciate that such purification operations may be performed at a variety of appropriate points in the process.

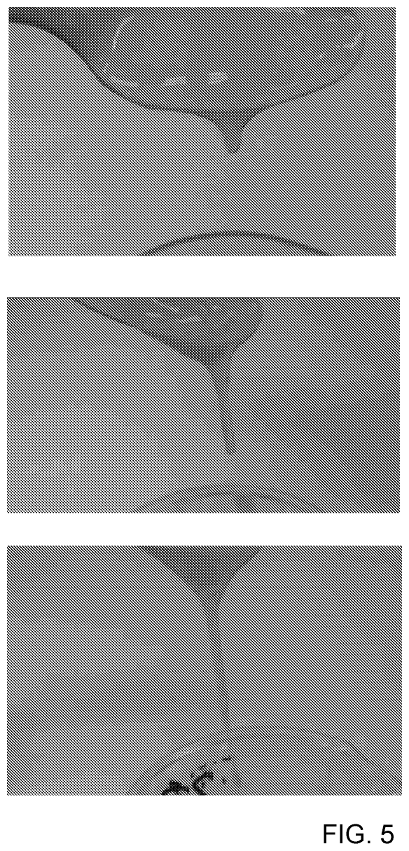

The pregelatinized starches described herein can provide a wide variety of textural benefits. For example, in certain embodiments as otherwise described herein, a pregelatinized starch can provide a low degree of cohesiveness (e.g., as measured by stringiness) in aqueous media. Such pregelatinized starches can be used to provide food product, such as gravies, sauces or dressings, with a desirably low cohesiveness. Stringiness can be determined by a sensory panel, e.g., a panel of testers trained to determine sensory characteristics of food ingredients, by comparison with the pictures in FIG. 5 (stringiness values of 3, 6 and 9, top-to-bottom). To prepare a starch sample for the stringiness evaluation, the starch is mixed with propylene glycol at 1:1 ratio using a plastic spatula until the starch is wet. The starch/propylene glycol mixture is placed under a Caframo mixer that is set at 825 RPM. The mixer is activated and the 1% (w/w) salt water is poured into the container holding the starch mixture. A spatula is used to make sure the starch is completely exposed to the salt water. The total amount of starch mixture is 2500 grams and the starch concentration is 6.5% (on a dry solids basis). The mixture is blended for 10 minute at 825 RPM. The starch paste is divided into 10 equal parts and put into 8 oz covered jars. Each jar has approximately 250 grams of product. The starch is continued to hydrate for 1 hour before evaluation. To determine stringiness, the sample is stirred well, then a spoonful of the material is scooped out of the jar and dropped slowly back into the container. The length of the tail when the starch leaves the spoon is observed and compared with the pictures of FIG. 5 to determine a stringiness value. In certain embodiments, a starch as otherwise described herein has a stringiness value of 5 or less, or 4 or less, or in the range of 1-5, or 1-4, or 2-5 or 2-4.

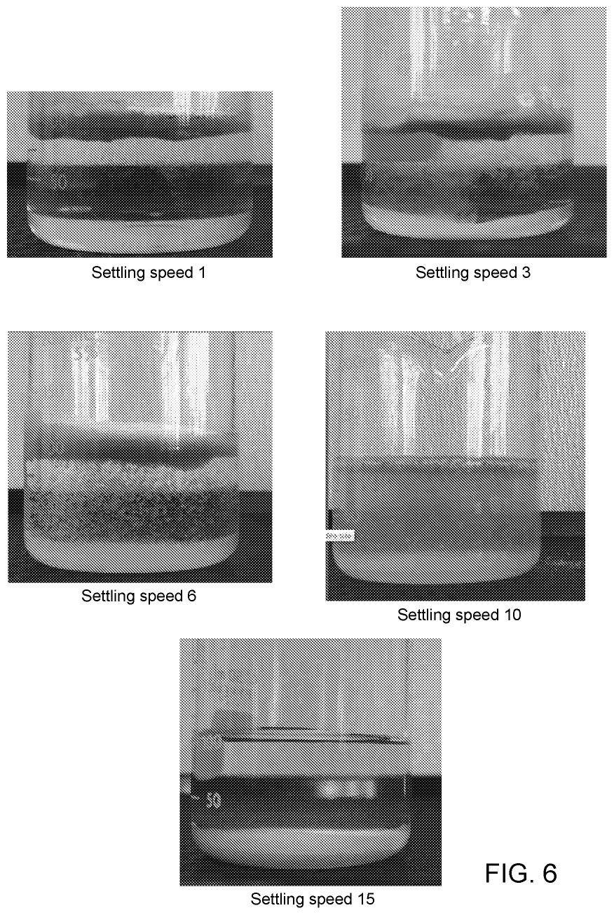

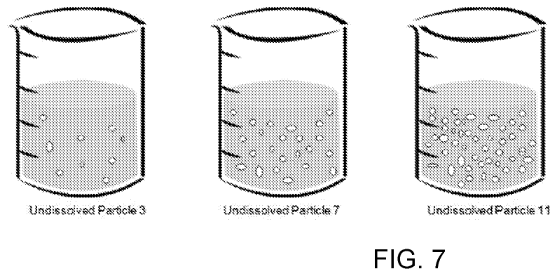

In certain embodiments as otherwise described herein, a pregelatinized starch is well-dispersible in aqueous media, e.g., with fast settling speed and a low degree of undispersed material present as particles or clumps. The dispersibility can be evaluated by dumping 5 grams of starch (as is) into 95 grams of 1% (w/w) salt water in a 250 mL beaker. The panelists observe the settling speed of the starch particles over a 10 second timeframe, with comparison to the pictures in FIG. 6 being used to determine a settling speed value. In certain embodiments as otherwise described herein, a starch of the disclosure has a settling speed value of at least 4, or at least 5, or in the range of 4-8, 4-7, 5-8 or 5-7. The panelists then use mini whisk to stir the starch solution with moderate speed for 1 minute and assess the initial thickness, floating number, floating area, sediment (amount of settled particles at the bottom), clump (large undissolved particles in solution), graininess, phase separation, and thickness after 3 minutes. In certain embodiments, there are substantially no clumps or floaters, Alter the stirring, the amount of undissolved particles can be compared with the pictures in FIG. 7. Desirably, the amount of undissolved particles is no more than that shown in the “Undissolved Particle 3” picture.

Notably, certain such pregelatinized starches can provide high dispersibilities without being agglomerated. Accordingly, in certain embodiments as otherwise described herein, the pregelatinized starch is not agglomerated.

In certain embodiments as otherwise described herein, a pregelatinized starch has a low rate of hydration. Hydration that is too fast can lead to clumping of the pregelatinized starch when it is dispersed in aqueous media. In contrast, a slower rate of hydration can allow for the minimization of clumping of the pregelatinized starch when it is dispersed.

In certain embodiments as otherwise described herein, a pregelatinized starch is tolerant to shear. Shear tolerance can be measured by comparing sedimentation volume and solubles values of the starch before and after shear processing. In certain desirable embodiments as otherwise described herein, the sedimentation volume increases by no more than 25%, or even no more than 10% upon shear processing. In certain desirable embodiments, the amount of solubles increases by no more than 25%, or even no more than 10% upon shear processing. In certain embodiments as otherwise described herein, the starch has a degree of fragmentation of no more than 50%, no more than 30%, or even no more than 10% after shear processing. In certain such embodiments, the “shear processing” is treatment in a Waring blender (Model 51BL32) by shearing at 30V for five seconds. The starch can optionally be cooked (e.g., by the RVA conditions) before shear processing.

Another aspect of the disclosure is a method for making a pregelatinized starch as described herein. The method includes providing an ungelatinized starch moistened with an aqueous medium; and drum-drying the moistened ungelatinized starch under conditions to pregelatinize the starch, e.g., to a degree as described above with respect to the pregelatinized starches of the disclosure. In certain such embodiments, the ungelatinized starch is stabilized, e.g., by acetylation, as described above with respect to the pregelatinized starches of the disclosure. And in certain such embodiments, the ungelatinized starch is cross-linked, e.g., by phosphate or adipate, as described above with respect to the pregelatinized starches of the disclosure. The ungelatinized starch can be any of the starch types as described above. The person of ordinary skill in the art can use conventional drum-drying techniques to provide the starches described herein.

Another aspect of the disclosure is a pregelatinized starch made by a method as described herein.

Another aspect of the disclosure is a method for preparing a food product, including dispersing a pregelatinized starch as described herein in a food product. The dispersion can be performed at a variety of temperatures. Notably, as the starch is pregelatinized, the dispersion need not be performed at high temperatures. Accordingly, in certain embodiments, the pregelatinized starch is dispersed in the food product at a temperature of no more than 95° C., e.g., no more than 90° C., no more than 70° C., or even no more than 50° C. In certain embodiments of the methods as otherwise described herein, the pregelatinized starch is dispersed in the food product at a temperature in the range of 15−95° C., e.g., 15-90° C., 15-70° C., 15-50° C., 15-30° C., 20-95° C., 20-90° C., 20-70° C., or 20-50° C. Of course, the pregelatinized starch can be dispersed in food at a different temperature, e.g., a higher temperature than those described here. For example, in some cases pregelatinized starches can be used in high-sugar foods in which cooking temperatures are very high. The pregelatinized starches can help to provide hydration in the presence of the sugar, which would otherwise prevent non-pregelatinized starch in the food from cooking.

The dispersion of the pregelatinized starch can be performed such that the starch granules remain substantially undisintegrated in the food product. For example, in certain embodiments of the methods as otherwise described herein, at least 50% (e.g., at least 75%, or even at least 90%) of the starch granules swell but do not substantially disintegrate when dispersed in the food product.

Another aspect of the disclosure is a food product that includes a starch as described herein dispersed therein. Desirably, the starch granules of the pregelatinized starch are substantially undisintegrated in the food product. For example, in certain embodiments of the methods as otherwise described herein, at least 50% (e.g., at least 75%, or even at least 90%) of the starch granules are swollen but not substantially disintegrated in the food product.

The pregelatinized starches of the disclosure can be used in a variety of food products. For example, in certain embodiments of the methods and food products as otherwise described herein, the food product is a liquid. In certain embodiments of the methods and food products as otherwise described herein, the food product is a soup, a gravy, a sauce (e.g., a mayonnaise, a white sauce or a cheese sauce), a dressing (e.g., a salad dressing, e.g., pourable or spoonable), a filling or topping (e.g., a fruit filling or topping), or a dairy product (e.g., a yogurt, a sour cream or a quark). The pregelatinized starches of the disclosure can be useful in egg-free food products, e.g., to provide properties otherwise provided by eggs; accordingly, in certain embodiments of the methods and food products as otherwise described herein, the food product is egg-free. For example, the pregelatinized starches of the present disclosure can be used in various embodiments in salad-dressings, mayonnaises, and various other oil/water emulsions such as cheese sauces, as well as in high-sugar fillings such as pie fillings.

In various additional embodiments, the food product can be, for example, a tomato-based product, a soup, a pudding, a custard, a cheese product, a cream filling or topping, a syrup (e.g., a lite syrup), a beverage (e.g., a dairy-based beverage), a glaze, a condiment, a confectionary, a pasta, a frozen food, a cereal.

A variety of cooking methods can be used, for example, pasteurization, retorting, kettle cooking, batch cooking and ultra-high temperature processing.

The starches described herein can also be used to modify the properties of solid foods, e.g., baked goods, for example, acting as an anti-stalant to provide a softer product that retains a fresher texture after storage. Accordingly, in other embodiments, the food product is a baked good, e.g., a bread, a pastry, a pie crust, a donut, a cake, a biscuit, a cookie, a cracker, or a muffin. In such embodiments, the cooking can include baking. In some embodiments, the use of the starches described herein in a baked good (i.e., in the dough or batter thereof) can help reduce staling. In other embodiments, the starch can be included in, e.g., a filling inside the baked good.

A variety of other food products can advantageously be made using the starches of the present disclosure. For example, food products in which the starches of the present disclosure are useful include thermally-processed foods, acid foods, dry mixes, refrigerated foods, frozen foods, extruded foods, oven-prepared foods, stove top-cooked foods, microwaveable foods, full-fat or fat-reduced foods, and foods having a low water activity. Food products in which the starches of the present disclosure are particularly useful are foods requiring a thermal processing step such as pasteurization, retorting, high-temperature short-time treatment, or ultra high temperature (UHT) processing. The starches of the present disclosure are particularly useful in food applications where stability is required through all processing temperatures including cooling, freezing and heating.

Based on processed food formulations, the practitioner may readily select the amount and type of the starches of the present disclosure required to provide the necessary thickness and gelling viscosity in the finished food product, as well as the desired texture. Typically, the starch is used in an amount of 0.1-35%, e.g., 0.5-6.0%, by weight, of the food product.

Among the food products which may be improved by the use of the starches of the present disclosure are high acid foods (pH<3.7) such as fruit-based pie fillings, baby foods, and the like; acid foods (pH 3.7-4.5) such as tomato-based products; low acid foods (pH >4.5) such as gravies, sauces, and soups; stove top-cooked foods such as sauces, gravies, and puddings; instant foods such as puddings; pourable and spoonable salad dressings; refrigerated foods such as dairy or imitation dairy products (e.g., yogurt, sour cream, and cheese); frozen foods such as frozen desserts and dinners; microwaveable foods such as frozen dinners; liquid products such as diet products and hospital foods; dry mixes for preparing baked goods, gravies, sauces, puddings, baby foods, hot cereals, and the like; and dry mixes for predusting foods prior to batter cooking and frying.

In other embodiments, the food product is a confection.

The starches described herein can be used in a wide variety of other foods. For example, in certain embodiments of the starches and methods of the disclosure, the starch is used in a food selected from baked foods, breakfast cereal, anhydrous coatings (e.g., ice cream compound coating, chocolate), dairy products, confections, jams and jellies, beverages, fillings, extruded and sheeted snacks, gelatin desserts, snack bars, cheese and cheese sauces, edible and water-soluble films, soups, syrups, sauces, dressings, creamers, icings, frostings, glazes, tortillas, meat and fish, dried fruit, infant and toddler food, and batters and breadings. The starches described herein can also be used in various medical foods. The starches described herein can also be used in pet foods.

The starches described herein can allow for a variety of novel products and processes. For example, one embodiment of the disclosure is a method of making a dressing. The method includes combining water, acid (e.g., vinegar or lemon juice), a starch as described herein and egg yolks to provide a homogeneous mixture. To that homogenous mixture, oil is added and emulsified to provide the sauce. In another embodiment, a method for making a dressing includes combining water, acid (e.g., vinegar or lemon juice) and egg yolks to form a homogeneous mixture. To that homogeneous mixture, a slurry of a starch of the disclosure in oil is added an emulsified to provide the sauce. As the person of ordinary skill in the art, flavorings, seasonings, salt and sweeteners can be added as desired at any point in the process.

The starches of the present disclosure may also be used in various non-food end use applications where chemically modified (crosslinked) inhibited starches have conventionally been utilized, such as cosmetic and personal care products, paper, packaging, pharmaceutical formulations, adhesives, and the like.

Based on processed food formulations, the person of ordinary skill in the art may readily select the amount and type of the starches of the present disclosure required to provide the necessary texture and viscosity in the finished food product. Typically, the starch is used in an amount of 0.1-35%, e.g., 0.1-10%, 0.1-5%, 1-20%, 1-10%, or 2-6%, by weight, of a finished food product. The starches described herein can also be used in preblends and dry mixes, e.g., in amounts in the range of 0.1-95%, e.g., 0.1-80%, 0.1-50%, 0.1-30%, 0.1-15%, 0.1-10%, 0.1-5%, 1-95%, 1-80%, 1-50%, 1-30%, 1-15%, 1-10%, 5-95%, 5-80%, 5-50%, 5-30%, 20-95%, 20-80%, or 20-50%.

An example of a method for producing a pregelatinized starch is provided: a native starch is dispersed in water at, for example, 30 to 40% solids, in the presence of sodium sulfate (e.g., 1-15%, based on dry starch weight), at non-elevated temperatures (e.g., 18-40° C., or 20-30° C. The pH of the slurry is adjusted to 11.5-12.0 with a strong base, for example sodium hydroxide. Phosphorous oxychloride, 0.05-0.15%, preferably 0.09-0.1% by weight on dry starch basis is added to the stirred slurry, and allowed to mix for 30 minutes. The pH is adjusted to closer to neutral, for example 8.2-9.0, by the addition of a dilute acid, such as hydrochloric or sulfuric, for example 1-12 N. Acetic anhydride (e.g., 5.0-6.1% or 5.5-6.0% on a dry weight basis) is slowly added to the slurry. The pH of the slurry is maintained slightly basic, for example 8.0-8.8 with an aqueous base for example sodium hydroxide or sodium carbonate. After the acetic anhydride addition is completed, the pH is lowered, for example to 4.5-7.0, by the addition of a dilute acid, such as hydrochloric or sulfuric, for example 1-12 N. The slurry is dewatered and washed with water to remove the salts, by standard procedures, such as centrifuge or filtration. The resulting material is then redispersed in water to produce a starch slurry at 25-42% (e.g., 35-42%) solids. The slurry may be filtered to improve the color, then re-slurried. The slurry is dried on a Gouda Model E5/5 single drum dryer (500 mm×500 mm). The drum is operated at elevated steam pressures 90-140 PSI, preferably, at least 100 PSI and preferably 6-8 RPM. In certain particular embodiments, the starch is at 36-38% solids and the dryer is operated at 125 PSIg and 8 RPM. The resulting heavy films are collected and milled to provide flake-like particles of the desired particle size.

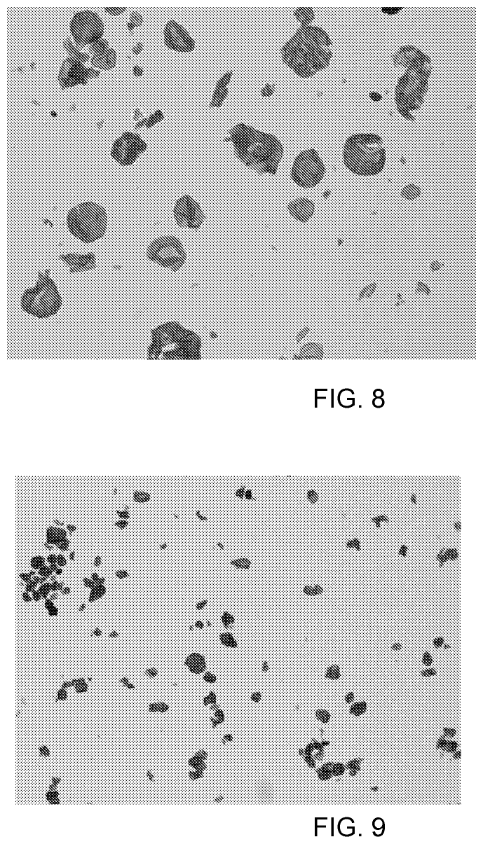

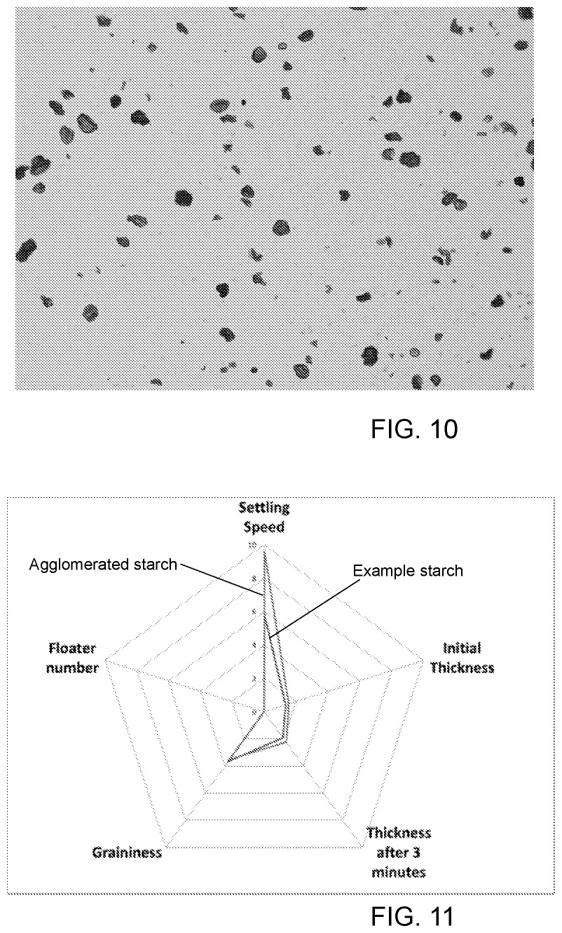

A pregelatinized starch made as described in the example above was subjected to the RVA viscosity measurement conditions, and examined by microscopy; FIG. 8 is the resulting micrograph. Notably, the starch granules remain substantially intact, even though the starch was processed by drum drying. A pregelatinized starch made as described in the example above was treated to the RVA conditions, then transferred to a Waring blender (Model 51BL32), and sheared at 30V for five seconds. The paste was diluted to 1% with deionized water, then diluted 1:1 with 0.1N KI to stain for imaging. Micrographs of the starch granules both after dispersion and after shear processing are provided as FIGS. 9 and 10, respectively. The pregelatinized starch of the disclosure was stable to the shear conditions, as evidenced by the substantially intact granules.

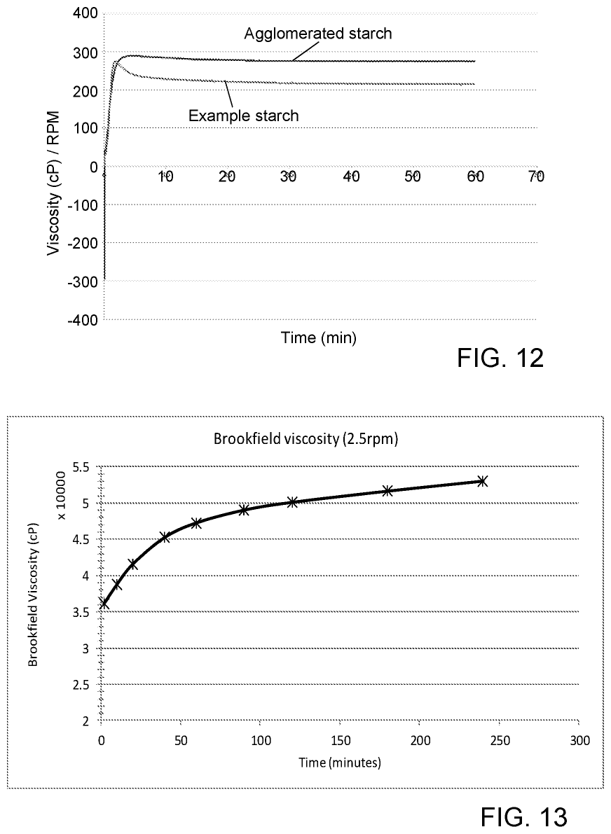

The dispersion behavior of a pregelatinized starch made as described in the example above was compared with the dispersion behavior of an agglomerated starch. As shown in the chart of FIG. 11, the pregelatinized starch of the disclosure performed similarly to the agglomerated starch, despite not being agglomerated itself. And the chart of FIG. 12 demonstrates that the example material builds viscosity quickly when dispersed in water.

An example of a salad dressing (mayonnaise-type) recipe is provided below:

Mass calculations for dressing

| | Mass % |
|---|---|
| Vegetable oil | 40.0 |
| Water | 31.54, 31.04 |
| Sucrose | 11.0 |
| Vinegar (120 Grain) | 7.81 |
| Egg yolk, pasteurized | 4.0 |
| STARCH | 3.0, 3.5 |
| Salt | 1.65 |
| TOTAL | 100.0 |

Such a salad dressing can be made by adding water and vinegar to a Hobart mixer, mixing in the sucrose, salt and starch. (Starch can alternatively be added as a slurry in the oil.) Egg yolks are added, and the mixture is mixed until it is blended. The oil is added slowly with additional mixing to form a pre-emulsion. The mixture can be emulsified, e.g., by high-shear mixing (e.g., using shear conditions at least as stringent as shearing at 30V for five seconds in a Waring blender (Model 51BL32)) or by colloid mixing.

Brookfield viscosity measurements were taken using a Brookfield viscometer, using the Helipath setting with T-bar spindle B at 2.5 rpm. Measurements were taken in triplicate, using three different subsamples of the material, Brookfield viscosity measurements were taken at the following time points: 2 min, 10 min, 20 min, 40 min, 60 min, 90 min, 120 min, 180 min, and 240 min.

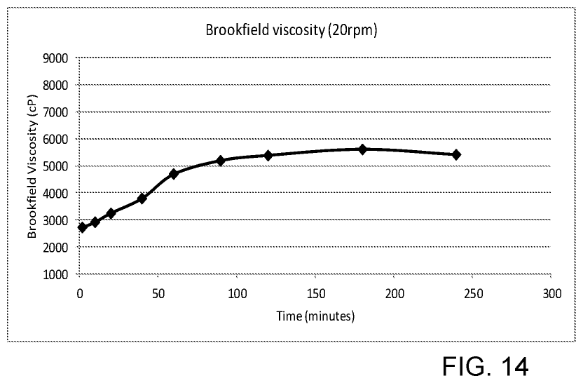

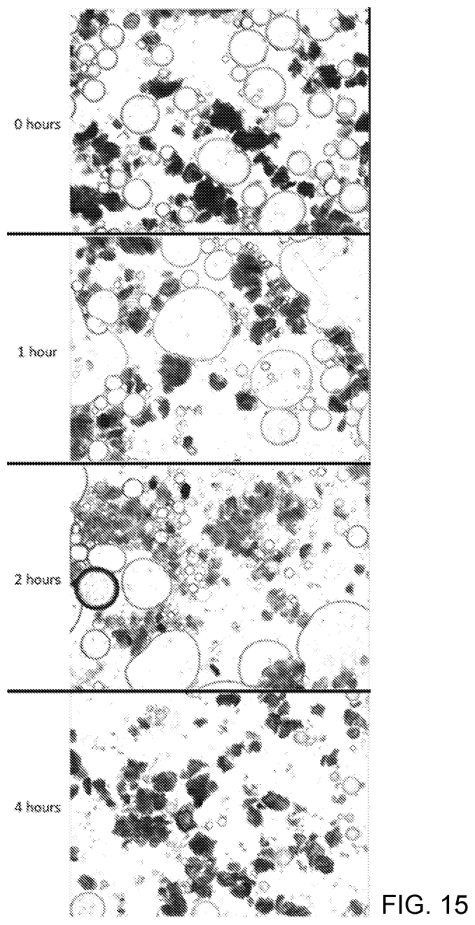

Brookfield viscosity measurement of the pre-emulsion exhibited increasing viscosity over time until a point of apparent plateau. The measurements for the 3 wt % and 3.5 wt % pre-emulsions (FIGS. 13 and 14, respectively) were collected with different spindles and so cannot be directly compared, but the graph (FIG. 2) can be used to compare the amount of viscosity change over time.

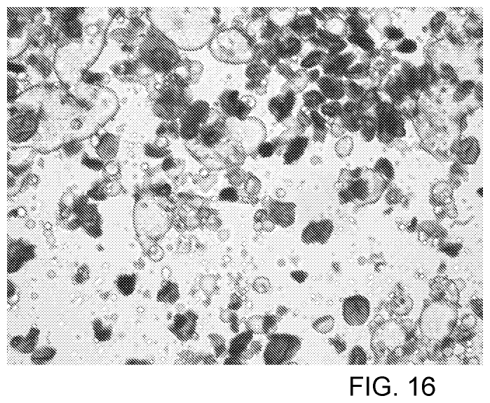

Microscopy demonstrated that the starch granules swelled somewhat over time, as shown in the micrographs of the 3.5% pre-emulsion of FIG. 15 (iodine stained, 200×). However, the swelling over time was relatively low, i.e., as a result of the low-to-medium sedimentation values of the starch. The starches of the disclosure at low and medium sedimentation volume values delivered good, stable viscosity performance after colloid milling, with a Brookfield viscosity of about 7×10⁵ cP that was stable for at least 5 days. The salad dressing had favorable sensory properties (e.g., cuttability, firmness, jiggle/elasticity, maintenance of shape, pull/resistance and thickness) as compared to a commercial dressing reference. And even alter colloid milling, the granules have relatively little swelling, as shown in the micrograph of FIG. 16. Notably, the relatively low swelling performance of the pregelatinized starches of the disclosure even after colloid milling highlights their potential for use in high-shear applications.

The particulars shown herein are by way of example and for purposes of illustrative discussion of various aspects and embodiments of the materials and methods of the present disclosure, and are presented in the cause of providing what is believed to be the most useful and readily understood description of the principles and conceptual aspects thereof. In this regard, no attempt is made to show details of the starches and methods described herein in more detail than is necessary for the fundamental understanding thereof, the description taken with the drawings and/or examples making apparent to those skilled in the art how various forms thereof may be embodied in practice. Thus, before the disclosed materials and methods are described, it is to be understood that the aspects described herein are not limited to specific embodiments, apparati, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the materials and methods disclosed herein (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. Ranges can be expressed herein as from one particular value, and/or to another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the materials and methods of the disclosure and does not pose a limitation on the scope of the materials and methods otherwise disclosed. No language in the specification should be construed as indicating any non-claimed element as being essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained in the materials and methods of the disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the materials and methods disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified.

Some embodiments of the methods and materials are described herein. Of course, variations on these described embodiments will become apparent to those of ordinary skill in the art upon reading the foregoing description. The present inventors expect skilled artisans to employ such variations as appropriate, and the intend for the materials and methods of the disclosure to be practiced otherwise than specifically described herein. Accordingly, this disclosure contemplates all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents and printed publications throughout this specification. Each of the cited references and printed publications are individually incorporated herein by reference in their entirety.

In closing, it is to be understood that the embodiments of the methods and materials disclosed herein are illustrative of the principles of the present disclosure. Other modifications that may be employed are within the scope of the disclosure. Thus, by way of example, but not of limitation, alternative configurations of the materials and methods of the present disclosure may be utilized in accordance with the teachings herein. Accordingly, the present disclosure is not limited to that precisely as shown and described.

1-66. (canceled)

67. A pregelatinized, drum-dried starch having no more than 15 wt % solubles and a sedimentation volume in the range of 15 mL/g to 45 mL/g, the pregelatinized starch comprising starch granules, wherein at least 50% of the starch granules swell but do not substantially fragment when processed in 95° C. water.

68. A pregelatinized starch having no more than 15 wt % solubles and a sedimentation volume in the range of 15 mL/g to 45 mL/g, the pregelatinized starch comprising starch granules, wherein at least 50% of the starch granules swell but do not substantially fragment when processed in 95° C. water, the pregelatinized starch being in a substantially planar form.

69. The pregelatinized starch of claim 68, wherein the pregelatinized starch is a drum-dried starch.

70. The pregelatinized starch of claim 67, wherein the starch has a sedimentation volume in the range of 15 mL/g to 40 mL/g.

71. The pregelatinized starch of claim 67, having no more than 4% solubles.

72. The pregelatinized starch of claim 67, wherein at least 90% by weight thereof is in the form of individual sheet- or flake-like particles of material each having a thickness in the range of 20 microns to 250 microns.

73. The pregelatinized starch of claim 67, wherein the pregelatinized starch is stabilized by acetylation or hydroxypropylation.

74. The pregelatinized starch of claim 67, wherein the drum-dried starch has an acetylation level of 1% to 4% by weight.

75. The pregelatinized starch of claim 74, wherein the pregelatinized starch is cross-linked with phosphate or adipate.

76. The pregelatinized starch of claim 67, wherein the drum-dried starch has an acetylation level of 1.8% to 2.5% by weight.

77. The pregelatinized starch of claim 67, wherein the drum-dried starch has a hydroxypropylation level of 0.5% to 10% by weight.

78. The pregelatinized starch of claim 77, wherein the pregelatinized starch is cross-linked with phosphate or adipate.

79. The pregelatinized starch of claim 67, wherein the drum-dried starch has a hydroxypropylation level of 2% to 7% by weight.

80. The pregelatinized starch of claim 67, wherein at least 75% of the starch granules swell but do not substantially fragment when processed in 95° C. water.

81. The pregelatinized starch of claim 67, wherein the starch is a corn starch, a tapioca or cassava starch, a potato starch, a rice starch or a wheat starch.

82. The pregelatinized starch of claim 67, wherein the pregelatinized starch exhibits an increase of no more than 25% in sedimentation volume, an increase of no more than 25% in solubles, and a degree of fragmentation of no more than 30% upon shear processing by treatment in a Waring blender by shearing at 30V for 5 seconds.

83. The pregelatinized starch of claim 82, wherein the starch is cooked before shear processing.

84. A method for making a pregelatinized starch according to claim 68, comprising providing an ungelatinized starch moistened with an aqueous medium; and drum-drying the moistened ungelatinized starch under conditions sufficient to pregelatinize the starch.

85. A method for preparing a food product, comprising dispersing a pregelatinized starch according to claim 67 in a food product, wherein the food product is subjected to high-shear conditions with the starch dispersed therein.

86. A food product comprising a starch according to claim 67 dispersed therein.
